(19) United States
(12) Patent Application Publication
(10) Pub. No.: US 2021/0089674 A1
(43) Pub. Date: Mar. 25, 2021

(54) INFORMATION PROCESSING DEVICE, INFORMATION PROCESSING METHOD, AND PROGRAM

(71) Applicant: SONY CORPORATION, Tokyo (JP)

(72) Inventors: Yousuke KAWANA, Tokyo (JP); Kentaro IDA, Tokyo (JP); Fumihiko IIDA, Tokyo (JP)

(73) Assignee: SONY CORPORATION, Tokyo (JP)

(21) Appl. No.: 17/052,413

(22) PCT Filed: May 29, 2019
(86) PCT No.: PCT/JP2019/021433

§ 371 Date: Nov. 2, 2020

(30) Foreign Application Priority Data
Jun. 13, 2018 (JP) 2018-112710

(51) Int. Cl. G06F 21/62; H04N 9/31; G06F 21/60

(52) U.S. Cl. CPC G06F 21/6218; G06F 21/604; H04N 9/3194

(57) ABSTRACT

There is provided an information processing device including a presentation control unit (113) that controls presentation of content on the basis of position information of a first user, in which the presentation control unit controls a presentation position of the content in space on the basis of use authority information of the first user regarding the content.

### TECHNICAL FIELD

The present disclosure relates to an information processing device, an information processing method, and a program.

### BACKGROUND ART

In recent years, a technique for setting authority information related to content for each user is known. For example, a technique for setting, with respect to a window, content operation authority information and content browsing authority information for each user is disclosed (for example, refer to Patent Document 1). In the technique, content is not operated in a window for which a user not having operation authority is set. Furthermore, content is not presented in a window for which a user not having browsing authority is set.

### CITATION LIST

### Patent Document

Patent Document 1: Japanese Patent Application Laid-Open No. 2014-127388

### SUMMARY OF THE INVENTION

### Problems to be Solved by the Invention

However, if content cannot be operated or presented in a case where there is a user who does not have authority related to the content, convenience may not be improved for another user who has authority related to the content. Therefore, it is desired to provide a technique for controlling presentation of content so as to improve user convenience.

### Solutions to Problems

According to the present disclosure, there is provided an information processing device including a presentation control unit that controls presentation of content on the basis of position information of a first user, in which the presentation control unit controls a presentation position of the content in space on the basis of use authority information of the first user regarding the content.

According to the present disclosure, there is provided an information processing method including, by a processor, controlling presentation of content on the basis of position information of a first user, and, by the processor, controlling a presentation position of the content in space on the basis of use authority information of the first user regarding the content.

According to the present disclosure, there is provided a program for causing a computer to function as an information processing device including a presentation control unit that controls presentation of content on the basis of position information of a first user, in which the presentation control unit controls a presentation. position of the content in space on the basis of use authority information of the first user regarding the content.

### Effects of the Invention

As described above, according to the present disclosure, there is provided a technique for controlling presentation of content so as to improve user convenience. Note that the effects described above are not necessarily limited, and, in addition to or in place of the above-described effects, any of the effects described in the present specification or other effects which may be understood from the present specification may be exhibited.

### BRIEF DESCRIPTION OF DRAWINGS

FIG. 1 is a diagram illustrating a configuration example of an information processing system according to an embodiment of the present disclosure.

FIG. 2 is a block diagram illustrating a functional configuration example of an information processing device according to the embodiment.

FIG. 3 is a diagram illustrating an example of a correspondence between a user ID and a user attribute

FIG. 4 is a diagram illustrating an example of a correspondence among a content type, a user attribute, and operation authority information.

FIG. 5 is a diagram illustrating an example of a correspondence among a content type, a user attribute, and browsing authority information.

FIG. 6 is a diagram illustrating an example of a correspondence between a user attribute and an able level.

FIG. 7 is a diagram illustrating an example of a correspondence between a content type and a permission level.

FIG. 8 is a diagram illustrating an example of a correspondence among a user attribute, presentation area restriction information, and time restriction information.

FIG. 9 is a flowchart illustrating a flow of processing to assign content use authority information.

FIG. 10 is a diagram illustrating an example of projection position control of content in a case where there is one user in space.

FIG. 11 is a diagram illustrating a modification of changing of a projection position.

FIG. 12 is a diagram illustrating an example of an irradiation prohibited area.

FIG. 13 is a diagram illustrating an example of setting of height of an irradiation prohibited area.

FIG. 14 is a flowchart illustrating a flow of projection position control in a case where there is one user.

FIG. 15 is a diagram for describing an example of projection position control in a case where there is a plurality of users in space (in a case where operation authority is considered).

FIG. 16 is a diagram for describing an example of projection position control in a case where there is a plurality of users in space (in a case where operation authority is considered).

FIG. 17 is a diagram for describing an example of projection position control in a case where there is a plurality of users in space (in a case where operation authority is considered).

FIG. 18 is a flowchart illustrating a flow of projection position control in a case where there is a plurality of users in space (in a case where operation authority is considered).

FIG. 19 is a diagram for describing an example of projection position control in a case where there is a plurality of users in space (in a case where browsing authority is considered).

FIG. 20 is a diagram for describing an example of projection position control in a case where there is a plurality of users in space (in a case where browsing authority is considered).

FIG. 21 is a diagram for describing an example of projection position control in a case where there is a plurality of users in space (in a case where browsing authority is considered).

FIG. 22 is a flowchart illustrating a flow of projection position control in a case where there is a plurality of users in space (in a case where browsing authority is considered).

FIG. 23 is a block diagram illustrating a hardware configuration example of the information processing device.

### MODE FOR CARRYING OUT THE INVENTION

A preferred embodiment of the present disclosure will be described below in detail with reference to the appended drawings. Note that, in this specification and the drawings, components having substantially the same functional configuration are provided with the same reference signs, so that repeated description of these components is omitted.

Furthermore, in this specification and the drawings, there may be a case were a plurality of components having substantially the same functional configuration is distinguished from one another by providing different numerals after the same reference sign. However, in a case where each of the plurality components having substantially the same functional configuration does not particularly need to be distinguished, the same reference sign alone will be provided.

Note that the description will be made in the following order.

0. Background

1. Embodiment of present disclosure

1.1. System configuration example

1.2. Functional configuration example

1.3. Functional details of information processing system

1.3.1. Assignment of authority information

1.3.2. Projection position control: one user

1.3.3. Projection position control: operation authority for plurality of users

1.3.4. Projection position control: browsing authority for plurality of users

1.4. Hardware configuration example

2. Conclusion

<0. Background>

In recent years, touch panel-equipped apparatuses (for example, smartphones, tablet terminals, and the like), which have an advantage of allowing for intuitive operation, have rapidly spread. Touch panel-equipped apparatuses are widely used by children and adults of all ages for their easy-to-understand operation. Accordingly, there is an increasing demand for “parental control”, which is an initiative for a parent to monitor and restrict use, by a child, of an information communication apparatus, such as a personal computer or mobile phone.

In general, parental control for such a terminal of various kinds may be set by selecting a function to be restricted from a setting menu, or may be set by installing a specific application. Therefore, it is general that a user performs setting for parental control manually. In the technique, in a case where a single terminal is used by a plurality of users, a parental control setting must be manually changed as a user who uses the terminal is changed.

Furthermore, in recent years, a technique for setting authority information related to content for each user is known. For example, a technique for setting, with respect to a window, content operation authority information and content browsing authority information for each user is disclosed. In the technique, content not operated in a window for which a user not having operation authority is set. Furthermore, content is not presented in a window for which a user not having browsing authority is set.

However, if content cannot be operated or presented. a case were there is a user who does not have authority related to the content, convenience is not improved for another user who has authority related to the content. For example, the another user may want to operate the content or may not browse the content. Therefore, in an embodiment of the present disclosure, a technique for controlling presentation of content so as to improve user convenience will be mainly described.

Specifically, application of the technique for setting, with respect to a window, content operation authority information and content browsing authority information for each user is considerably restricted, because an area in which content is presented is limited to a top of a table. In addition, the technique does not fully utilize an advantage that content may be presented at any area in space (for example, living space such as a room). Furthermore, in the technique, a plurality of windows is shared by a plurality of users, and therefore, appearance of the plurality of windows is complicated.

In the embodiment of the present disclosure, a system automatically understands a user who operates content (hereinafter, also simply referred to as a “using user”) and automatically switches the using user, and therefore, it is possible to save time and effort to reset parental control manually. Furthermore, in the embodiment of the present disclosure, a user can be anywhere in space to operate content, because the content may be presented at any area in the space. Furthermore, the embodiment of the present disclosure, a single piece of content may be presented by a drive-type projector, and therefore, discomfort and danger to the user by irradiation from the drive-type projector may be reduced as compared with a case where a plurality of pieces of content is presented.

The background of the embodiment of the present disclosure has been described above.

<1. Embodiment of Present Disclosure>

[1.1. System Configuration Example]

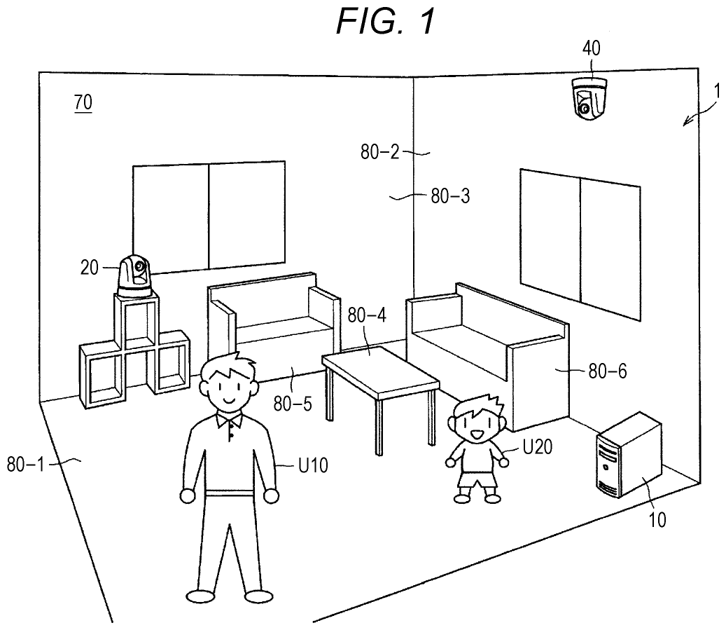

First, a configuration example of an information processing system according to an embodiment of the present disclosure will be described with reference to the drawings. FIG. 1 is a diagram illustrating a configuration example of an information processing system. according to an embodiment of the present disclosure. As illustrated in FIG. 1, an information processing system 1 includes an information processing device 10, a sensor unit 20, and a presentation unit 40. The information processing system 1 is installed in space 70. Here, there is assumed a case where the space 70 is living space (room, or the like). However, the space 70 is not limited to living space. For example, the space 70 may be an office, a conference room, or another place.

The space 70 is formed by surfaces surrounding the space 70, such as a floor surface 80-1, a wall surface 80-2, and a wall surface 80-3. However, a surface surrounding the space 70 is not limited to these. For example, the surfaces surrounding the space 70 may include a ceiling surface, or the like. Furthermore, there are objects such as a table 80-4, a chair 80-5, and a chair 80-6 in the space 70. An object in the space 70 is not limited to these. For example, another object. (for example, a home electrical appliance, or the like) may be in the space 70.

In the example illustrated in FIG. 1, there are a user U10 and a user U20 in the space 70. In the embodiment of the present disclosure, implementation of parental control is assumed as an example. Therefore, as an example, FIG. 1 illustrates a case where the user U10 is a “father” and the user U20 is a “son”. However, a combination of the user U10 and the user U20 is not limited to this example.

For example, the user U10 may be a “mother” instead of a “father”. Furthermore, the user U20 may be a “daughter” instead of the “son”. Alternatively, the combination of the user U10 and the user U20 may be a couple, siblings (regardless of each gender), or friends. Alternatively, in a case where the space 70 is an office, the combination of the user U10 and the user U20 may be employees. Note that the number of users in the space 70 does not have to be two, and may be one, or three or more.

The information processing device 10 may be configured to include a computer. For example, the information processing device 10 may be configured to include a personal computer (PC). The information. processing device 10 is configured to be capable of communicating with the sensor unit 20 by wire or wirelessly. The information processing device 10 may acquire sensor data of various kinds detected by the sensor unit 20. Furthermore, the information processing device 10 is configured to be capable of communicating with the presentation unit 40 by wire or wirelessly. The information processing device 10 may control presentation of content by the presentation unit 40.

The sensor unit 20 has a first sensor that recognizes environment (hereinafter, also referred to as an “environment recognition sensor”). Here, environment recognized by the environment recognition sensor may include a three-dimensional shape of the space 70. Therefore, the environment recognition sensor may recognize a three-dimensional shape of an object (for example, the table 80-4, the chair 80-5, chair 80-6, or the like) in the space 70 besides a surface (for example, the floor surface 80-1, the wall surface 80-2, the wall surface 80-3, or the like) surrounding the space 70. In addition, environment recognized by the environment recognition sensor may include a material of a plane surface, color of a plane surface, texture of a plane surface, or the like.

Moreover, the environment recognition sensor may detect brightness of the space 70 on the basis of sensing data from an illuminance sensor or a temperature sensor. Alternatively, in a case where the environment recognition sensor has a reading device, and a radio frequency identifier (RFID) tag in which an ID for identifying a type of an object is recorded is previously attached to an object (for example, the floor surface 80-1, the wall surface 80-2, the wall surface 80-3, or the like) in the space 70, a type of the object and arrangement of the object may be detected by the environment recognition sensor, on the basis of the ID read from the RFID tag by the reading device and a place where the ID has been read.

Note that the environment recognition sensor may include a light detection and ranging (LiDAR) sensor or a web camera. However, a type of the environment recognition sensor is not particularly limited.

Furthermore, the sensor unit 20 has a second sensor (hereinafter, also referred to as “person recognition. sensor”) that recognizes a person (user) in the space 70. The person recognition sensor detects presence or absence of a user in the space 70. Then, in a case where there is a user in the space 70, the person recognition sensor recognizes the number of users in the space 70, a position and posture of each user (body orientation, face orientation, or the like), a gesture of each user, or the like. The person recognition sensor can identify each user individually. The person recognition sensor may include a motion detection system of various kinds, and may recognize motion of a person by the motion detection system of various kinds.

Moreover, the sensor unit 20 has a third sensor (hereinafter, also referred to as “operation recognition sensor”) that recognizes operation performed on content by a using user. Moreover, the operation recognition sensor may recognize start of operation on content by the using user. The operation recognition sensor may include an infrared camera or a depth sensor (for example, a high-resolution depth sensor), and fine movement of a finger and hand of the user may be recognized by the infrared camera or the depth sensor.

Note that, in the embodiment of the present disclosure, a case where an environment recognition sensor, a person recognition sensor, and an operation recognition sensor are incorporated in the same sensor unit 20 is mainly assumed. However, among the environment recognition sensor, the person recognition sensor, and the operation recognition sensor, one sensor may be separate from remaining two sensors, or each of the three sensors may be separate from one another. Furthermore, any two sensors or three sensors among the environment recognition sensor, the person recognition sensor, and the operation recognition sensor may be a common sensor.

The presentation unit 40 is a presentation device that presents content. More specifically, the presentation unit 40 presents content in the same space as the space 70 in which there is a user. In the embodiment of the present disclosure, a case where the presentation unit 40 includes a projector that projects content with projecting light is mainly assumed Furthermore, in the embodiment of the present disclosure, there is assumed a case where the presentation unit 40 includes a drive-type projector, the drive-type projector has a pan/tilt drive mechanism, and a presentation position (hereinafter, also referred to as “projection position”) of content is controlled to an arbitrary place by a pan/tilt mechanism. However, a presentation position of content by the presentation unit 40 may be controlled in any way.

For example, a mirror having a pan/tilt drive mechanism may be arranged on a front surface of a projector as an example of the presentation unit 40, and a presentation position of the content may be controlled to an arbitrary place in accordance with control of a reflection direction of the mirror. Alternatively, as the presentation unit 40, a display device of various kinds other than a projector may be used instead of the projector. A type of the display device is not particularly limited, and may be a liquid crystal display, an organic electro-luminescence (EL) display, or another display.

Furthermore, in the embodiment of the present disclosure, a case where content includes a moving image is mainly assumed. However, the content is not limited to a case of content including a moving image. For example, the content may include a still image.

Alternatively, the content is not limited to information perceived by a visual sense of the user. The content is only required to be information perceived by at least one of five senses (visual sense, auditory sense, tactile sense, gustatory sense, and olfactory sense) of a user.

For example, the presentation unit. 40 may include a tactile sense presentation device that presents a tactile sense to the user, may include an olfactory sense presentation device that presents an olfactory sense to the user by emitting scent to the user, or may include a device that gives the user a sense of temperature. Alternatively, the presentation unit 40 may be a speaker that presents an auditory sense to the user by emitting voice to the user. At this time, the presentation unit 40 may have a directional speaker and may be able to present voice as an example of content by the directional speaker, and a presentation position of the content may be controlled by the directivity being controlled.

A configuration example of the information processing system 1 according to the present embodiment has been described above.

[1.2. Functional Configuration Example]

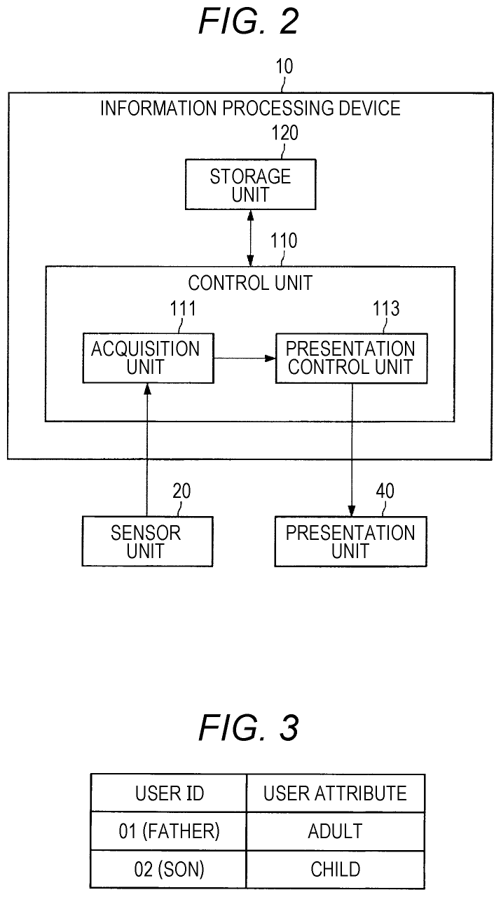

Next, a functional configuration example of the information processing device 10 according to the present embodiment will be described. FIG. 2 is a block diagram illustrating a functional configuration example of the information processing device 10 according to the present embodiment. As illustrated in FIG. 2, the information processing device 10 includes a control unit 110 and a storage unit 120. These functional blocks included in the information processing device 10 will be described below.

The control unit 110 executes control of each unit of the information processing device 10. Note that the control unit 110 may be configured by a processing device such as a central processing unit (CPU), for example. In a case where the control unit 110 is configured by a processing device such as a CPU, the processing device may be configured by an electronic circuit. As illustrated in FIG. 2, the control unit 110 has an acquisition unit 111 and a presentation control unit 113. These blocks that the control unit 110 has will be described in detail later.

The storage unit 120 is a recording device that stores a program executed by the control unit 110 or stores data necessary for executing the program. Furthermore, the storage unit 120 temporarily stores data for calculation by the control unit 110. Note that the storage unit 120 may be a magnetic storage unit device, a semiconductor storage device, an optical storage device, or a magneto-optical storage device.

A functional configuration example of the information processing device 10 according to the present embodiment has been described above.

[1.3. Functional Details of Information Processing System]

Next, functional details of the information processing system 1 will be described.

(1.3.1. As of Authority Information)

First, the information processing device 10 assigns content use authority information to each user. In the following, as illustrated in FIG. 1, the user U10 (second user) is assumed to be a “father” and the user U20 (first user) is assumed to be a “son”. Furthermore, in the following, a case where content use authority information includes both content browsing authority information (hereinafter, also simply referred to as “browsing authority information”) and content operation authority information (hereinafter, also simply referred to as “operation authority information”) is mainly assumed. However, content use authority information may include either the browsing authority information or the operation authority information.

A function to assign content use authority information to each user will be described below with reference to FIGS. 3 to 9.

FIG. 3 is a diagram illustrating an example of a correspondence between a user ID and a user attribute. As illustrated in FIG. 3, in accordance with a previous setting by a user, a user ID and a user attribute are previously linked to each other and stored in the storage unit 120. A user who performs the previous setting may be the user U10 “father”, the user U20 “son”, or another user.

In FIG. 3, “adult” and “child” are listed as examples of user attributes. Furthermore, in the example illustrated in FIG. 3, the user U10 “father” is linked to a user attribute “adult”, and the user U20 “son.” is linked to a user attribute “child”. However, a user attribute is not limited to these examples. Furthermore, a correspondence between a user ID and a user attribute is not limited to these examples.

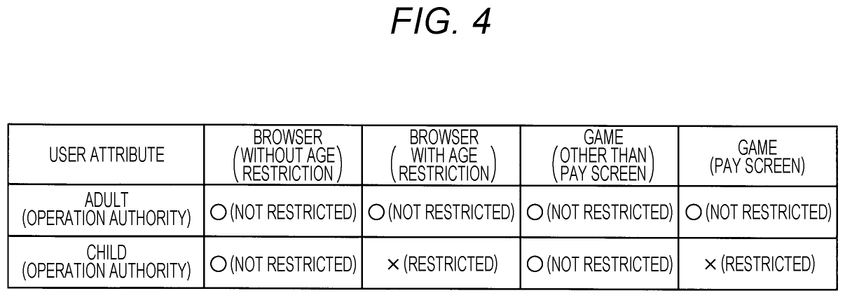

FIG. 4 is a diagram illustrating an example of a correspondence among a content type, a user attribute, and operation authority information. As illustrated in FIG. 4, operation authority information is previously linked to a content type and to a user attribute, and is stored in the storage unit 120. In FIG. 4, “browser (without age restriction)”, “browser (with age restriction)”, “game (other than pay screen)”, and “game (pay screen)” are listed as examples of content types.

Here, “browser” indicates that a type of a content launch application is a “browser application”, and “game” indicates that the type of the content launch application is a “game application”. Furthermore, “without are restriction”, “with age restriction”, “other than pay screen”, and “pay screen” are classifications of substance of content. Thus, a content type may include a type of a content launch application and a classification of substance of content, or may include only either one of these.

With reference to FIG. 4, it is illustrated that, for a user corresponding to the user attribute “adult”, operation authority over content that falls into the content type “browser (without age restriction)”, “browser (with age restriction)”, “game (other than pay screen)”, or “game (pay screen)” is not restricted. Meanwhile, with reference to FIG. 4, it is indicated that, for a user corresponding to the user attribute “child”, although operation is not restricted on content that falls into the content type “browser (without age restriction)” or “game (other than pay screen)”, operation authority over content that falls into the content type “browser (with age restriction)” or “game (pay screen)” is restricted.

Note that, in the example illustrated in FIG. 4, operation authority information is linked to a content type and a user attribute. However, operation authority information is not required to be directly linked to a content type and a user attribute. For example, operation authority information may be directly linked to content (content ID) and a user attribute. In this case, a content ID may be used instead of a content type.

Here, there is assumed a case where information illustrated in FIG. 4 is stored in the storage unit 120. For example, the environment recognition sensor recognizes environment in the space 70 at a time of an initial setting of the presentation unit 40. With this arrangement, the three-dimensional shape of the space 70 may be recognized. The environment recognition sensor transmits the recognized three-dimensional shape of the space 70 to the information processing device 10. Then, the person recognition sensor recognizes a user in the space 70.

For example, in a case where personal identification information (for example, a face image, a voiceprint, or the like) of the user U10 “father” previously registered, the person recognition sensor recognizes that the user U10 “father” is in the space 70 if having recognized, from the space 70, personal identification information that matches the personal identification information of the user U10 “father”. It may be recognized in a similar manner that the user U20 “son” is in the space 70. The person recognition sensor transmits the recognized ID of the user (user ID) to the information processing device 10.

Note that the person recognition sensor may directly recognize a user attribute without recognizing an individual user. For example, in a case where a user attribute and a characteristic corresponding to the user attribute (for example, age, body height, or the like) are previously linked to each other, and the person recognition sensor has recognized the characteristic corresponding to the user attribute from the space 70, it may be recognized that the user having the user attribute is in the space 70. At this time, the person recognition sensor is only required to transmit the user attribute, instead of the user ID, to the information processing device 10.

Furthermore, processing at a time of the initial setting described above may be executed at every predetermined time, instead of at the time of the initial setting or in addition to the time of the initial setting.

Next, in the information processing device 10, the acquisition unit 111 acquires a user ID recognized by the person recognition sensor. The acquisition unit 111 acquires content use authority information (here, operation authority information) linked to a user attribute corresponding to a user ID and a content type (FIG. 4), and assigns the acquired content use authority information (here, operation authority information) to the user (user ID). Note that, in a case where a user attribute recognized by the person recognition sensor is acquired, the acquisition unit 111 is only required to acquire content use authority information linked to the acquired user attribute and a content type.

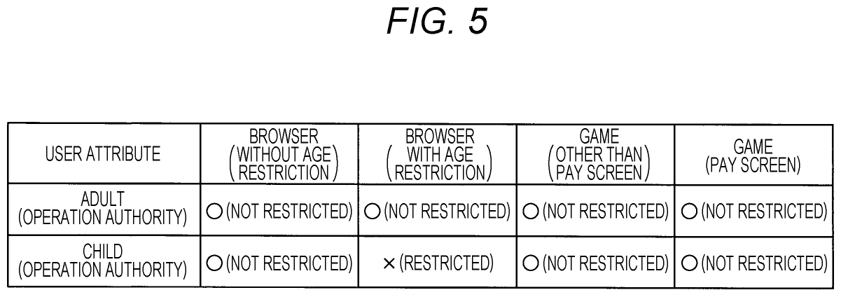

FIG. 5 is a diagram illustrating an example of a correspondence among a content type, a user attribute, and browsing authority information. As illustrated in FIG. 5, browsing authority information is previously linked to a content type and to a user attribute, and is stored in the storage unit 120. In FIG. 5, as similar to FIG. 4, “browser (without age restriction)”, “browser (with age restriction)”, “game (other than pay screen)” and “game (pay screen)” are provided as examples of content types.

With reference to FIG. 5, it is illustrated that, for a user corresponding to the user attribute “adult”, browsing authority over content that falls into the content type “browser (without age restriction)”, “browser (with age restriction)”, “game (other than pay screen)”, or “game (pay screen)” is not restricted. Meanwhile, with reference to FIG. 5, it is illustrated that, for a user corresponding to the user attribute “child”, although browsing authority over content that falls into the content type “game (pay screen)” in addition to “browser (without age restriction)” and “game (other than pay screen)” is not restricted, operation authority over content that falls into the content type “browser (with age restriction)” is restricted.

Note that, in the example illustrated in FIG. 5, browsing authority information is linked to a content type and a user attribute. However, browsing authority information is not required to be directly linked to a content type and a user attribute. For example, browsing authority information may be directly linked to content (content ID) and a user attribute. In this case, a content ID may be used instead of a content type.

Here, there is assumed a case where information illustrated in FIG. 5 is stored in the storage unit 120. Environment recognition and person recognition are executed as similar to the above-description. In the information processing device 10, the acquisition unit 111 acquires a user ID recognized by the person recognition sensor. The acquisition unit 111 acquires content use authority information (here, browsing authority information) linked to a user attribute corresponding to a user. ID and a content type (FIG. 5), and assigns the acquired content use authority information (here, browsing authority information) to the user (user ID). Note that, in a case where a user attribute recognized by the person recognition sensor is acquired, the acquisition unit 111 is only required to acquire content use authority information linked to the acquired user attribute and a content type.

A case where content use authority information is directly linked to a content type and a user attribute has been mainly described above. However, a level (able level) may be directly linked to a user attribute, and a level (permission level) may be directly linked to a content type. At this time, the presentation control unit 113 may determine content use authority information on the basis of a relation of these levels (a relation between an able level and a permission level).

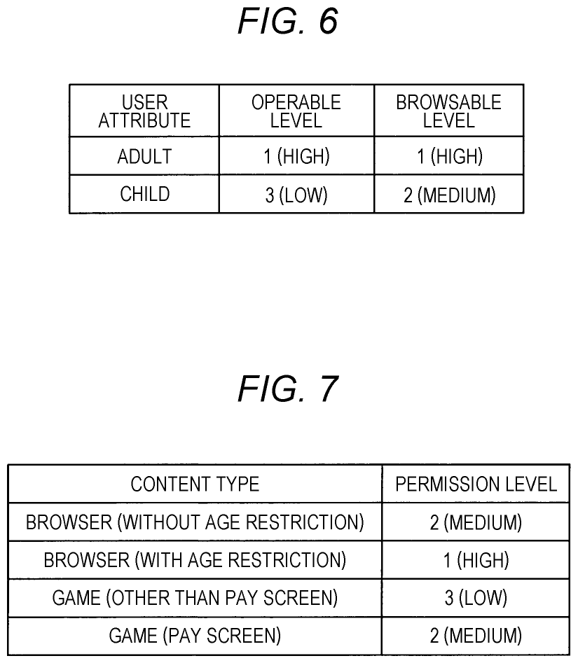

FIG. 6 is a diagram illustrating an example of a correspondence between a user attribute and an able level. As illustrated in FIG. 6, an operable level and a browsable level, which are examples of an able level, are previously linked to a user attribute, and are stored in the storage unit 120. In the example illustrated in FIG. 6, an operable level “1 (high)” and a browsable level “1 (high)” are linked to the user attribute “adult”, and an operable level “3 (low)” and a browsable level “2 (medium)” are linked to the user attribute “child”. Here, a case where a level is indicated by three levels, which are “1 (high)”, “2 (medium)”, and “3 (low)”, is mainly assumed. However, the level is not limited to three levels.

FIG. 7 is a diagram illustrating an example of a correspondence between a content type and a permission level. As illustrated in FIG. 7, a permission level is previously linked to a content type, and is stored in the storage unit 120. In the example illustrated in FIG. 7, a permission level “2 (medium)” is linked to the content type “browser (without age restriction)”, a permission level “1 (high)” is linked to the content type “browser (with age restriction)”, a permission level “3 (low)” is linked to the content type “game (other than pay screen)”, and the permission level “2 (medium)” is linked to the content type “game (pay screen)”.

Here, there is assumed a case where information illustrated in FIGS. 6 and 7 is stored in the storage unit 120. Environment recognition and person recognition are executed as similar to the above-description. In the information processing device 10, the acquisition unit 111 acquires a user ID recognized by the person recognition sensor. The acquisition unit 111 acquires able levels (operable level and browsable level) linked to a user attribute corresponding to a user ID (FIG. 6) and a permission level linked to a content type (FIG. 7), and the presentation control unit 113 determines content use authority information of each user on the basis of a relation between the able levels and the permission level. Note that, in a case were the user a tribute recognized by the person recognition sensor is acquired, the acquisition unit 111 is only required to acquire the able levels linked to the acquired user attribute and the permission level linked to the content type.

More specifically, in a case where an able level (operable level or browsable level) corresponding to a user attribute is equal to a permission level corresponding to a content type, or in a case where the able level is higher than the permission level, the presentation control unit 113 determines that a user corresponding to the user attribute has content use authority information corresponding to the content type. Meanwhile, in a case where an able level corresponding to a user attribute is lower than a permission level corresponding to a content type, the presentation control unit 113 determines that a user corresponding to the user attribute does not have content use authority information related to content corresponding to the content type (operation authority or browsing authority over the content is restricted). The presentation control unit 113 assigns the determined content use authority information to the user (user ID).

A case where content use authority information is linked to a content type and a user attribute has been mainly described above. However, content use authority information may be linked to another information substituting for a content type and a user attribute. Here, the another information is not particularly limited. In the following, as the another information, information related to a restriction on a projection position of content (hereinafter, also simply referred to as “presentation area restriction information”) and information related to a restriction on a presentation period of content (hereinafter, also simply referred to as “time restriction information”) will be described as examples.

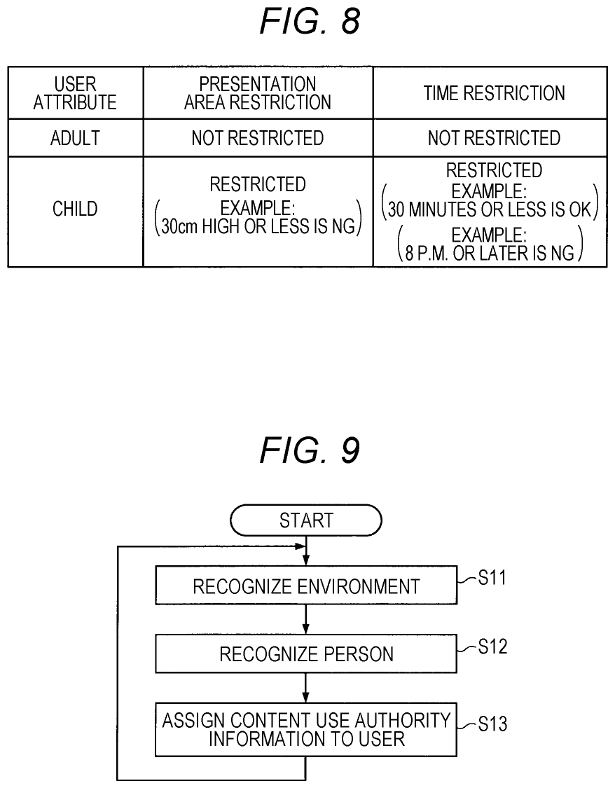

FIG. 8 is a diagram illustrating an example of a correspondence among a user attribute, presentation area restriction information, and time restriction information. As illustrated in FIG. 8, presentation area restriction information and time restriction information are previously linked to a user attribute, and are stored in the storage unit 120. With reference to FIG. 8, it is illustrated that a presentation area and presentation period of content are not restricted for a user corresponding to the user attribute “adult”. Meanwhile, with reference to FIG. 8, it is illustrated that a presentation area and presentation period of content are restricted for a user corresponding to the user attribute “child”.

For example, in order to prevent light emitted by the presentation unit 40 from hitting a body of a child, as illustrated in FIG. 8, a user corresponding to the user attribute “child” may be under a restriction that presentation of content to a place at a lower limit height (for example, 30 cm) or lower is impossible. That is, a user corresponding to the user attribute “child” may have authority (operation authority or browsing authority) that presentation of content is possible if a projection position of the content is higher than the lower limit height.

Alternatively, because browsing content for a long time may be harmful to health, as illustrated in FIG. 8, a user corresponding to the user attribute “child” may be under a restriction that presentation of content exceeding an upper limit time (for example, 30 minutes) per day is impossible. That is, a user corresponding to the user attribute “child” may have authority (operation authority or browsing authority) that presentation of content is possible if a presentation period of the content is equal to or shorter than the upper limit time.

Alternatively, because browsing content at a late time may be harmful to health, as illustrated in FIG. 8, a user corresponding to the user attribute “child” may be under a restriction that presentation of content after a certain time (for example, 8 p.m.) is impossible. That is, a user corresponding to the user attribute “child” may have authority (operation authority or browsing authority) that presentation of content is possible if presentation time of the content is before the certain time.

Here, there is assumed a case where information illustrated in FIG. 8 is stored in the storage unit 120. Environment recognition and person recognition are executed as similar to the above-description. In the information processing device 10, the acquisition unit 111 acquires a user ID recognized by the person recognition sensor. The acquisition unit 111 acquires browsing area restriction information and time restriction information linked to a user attribute corresponding to the user ID. The presentation control unit 113 determines content use authority information of each user on the basis of the browsing area restriction information. Furthermore, the presentation control unit 113 determines content use authority information of each user on the basis of the time restriction information. The presentation control unit 113 assigns the determined content use authority information to the user (user ID).

Note that, in a case where a user attribute recognized by the person recognition sensor is acquired, the acquisition unit 111 is only required to acquire the browsing area restriction information and time restriction information linked to the acquired user attribute.

FIG. 9 is a flowchart illustrating a flow of processing to assign content use authority information. As illustrated in FIG. 9, the environment recognition sensor recognizes environment in the space 70 at a time of an initial setting of the presentation unit 40 (S11). With this arrangement, the three-dimensional shape of the space 70 may be recognized. The environment recognition sensor transmits the recognized three-dimensional shape of the space 70 to the information processing device 10. Then, the person recognition sensor recognizes a person (user) in the space 70 (S12). The person recognition sensor transmits the recognized ID of the user (user ID) to the information processing device 10.

Next, in the information processing device 10, the acquisition unit 111 acquires a user ID recognized by the person recognition sensor. The acquisition unit 111 acquires content use authority information (here, operation authority information) on the basis of the user attribute corresponding to the user ID and assigns the acquired content use authority information to the user (user ID) (S13). When assignment of the content use authority information is finished, operation is shifted to S11. With this arrangement, S11 is executed at every predetermined time.

A function to assign content use authority information to each user has been described above.

(1.3.2. Projection Position Control: One User)

When content use authority information is assigned to a user as described above, the presentation control unit 113 controls a projection position of the content. In the following, an example of projection position control of a content will be described. First, a case where there is one user in the space 70 will be described.

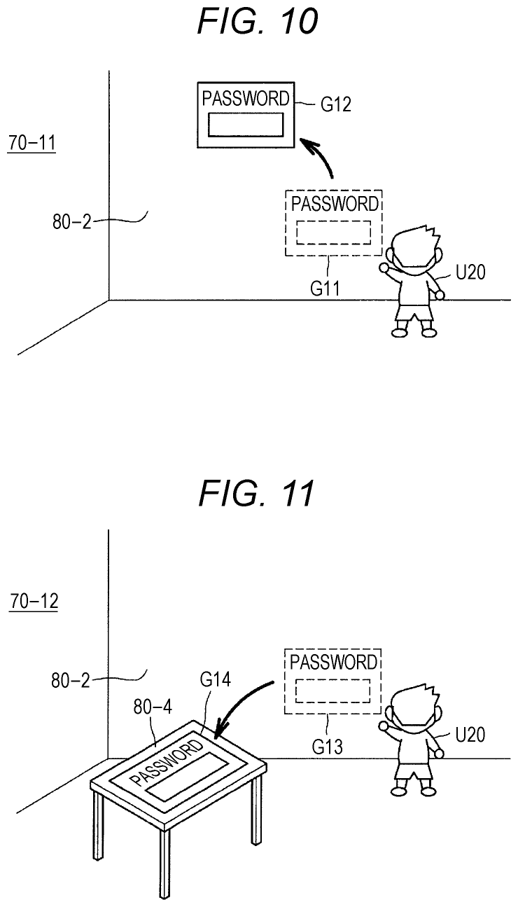

FIG. 10 is a diagram illustrating an example of projection position control of content in a case where there is one user in space. With reference to FIG. 10, there is the user U20 “son” in space 70-11. When start of operation by the user U20 “son” is recognized, the presentation control unit 113 recognizes the user U20 “son” as a using user and controls projection of content G11 on the basis of a position of the user U20 “son”.

The start of operation may be recognized in any way. For example, the start of operation may be recognized in response to touch operation to the wall surface 80-2 by the user U20 “son”, or may be recognized by a predetermined utterance by the user U20 “son” for giving an instruction on start of operation. Alternatively, start of operation may be recognized by the user U20 “son” entering the space 70-11 or may be recognized by current time reaching a previously determined time.

More specifically, the presentation control unit 113 controls the presentation unit 40 so that the content G11 is projected, by the presentation unit 40, at a position in the space 70-11 (in the example illustrated in FIG. 10, the wall surface 80-2 that is a surface close to a position of the user U20 “son”) corresponding to the position of the user U20 “son”. At this time, the presentation control unit 113 controls the projection position of the content Gil in the space 70-11 on the basis of content use authority information of the user U20 “son” related to the content G11.

If the content Gil cannot be operated or projected in a case where the user U20 “son” does not have use authority over the content Gil, convenience may not be improved for another user who has use authority over the content G11. Therefore, user convenience is expected to improve by the projection position of the content G11 being controlled on the basis of the content use authority information of the user U20 “son” related to the content G11.

As an example, in a case where the content use authority information of the user U20 “son” related to the content G11 indicates that the user U20 “son” does not have content use authority, the presentation control unit 113 is only required to change the projection position of the content G11. Meanwhile, in a case where the content use authority information of the user U20 “son” related to the content G11 indicates that the user U20 “son” has content use authority, the presentation. control unit 113 is only required to maintain the projection position of the content G11.

Here, it is assumed that the user U20 “son” does not have operation authority over content of which the content type is a password input screen. Thus, in a case where operation authority information of the user U20 “son” indicates that the user U20 “son” does not have operation authority, the presentation control unit 113 preferably moves the projection position of the content G11 away from the user U20 “son” (for example, the projection position is preferably moved to a position of content G12). With this arrangement, the user U20 “son” who does not have the operation authority has difficulty to browse or operate the content G11.

Note that a content type (for example, the content type is a password input screen) may be recognized in any way. For example, in a case where a content type is attached to a content, the content type may be recognized by acquiring the content type attached to the content. Alternatively, a content type may be recognized by an analysis of the content (for example, in a case where it is detected that the content is provided with a password input field, it may be recognized that the content type is a password input screen).

Note that, in the example illustrated in FIG. 10, a case where a child does not have browsing operation or operation authority over content of which the content type is a password input screen has been described. A content type over which a child preferably does not have browsing operation or operation authority is not limited to a password input screen. For example, a content type over which a child does not have browsing operation or operation authority may be a download screen, an agree/disagree selection screen, an application install/uninstall screen, moving image content, a pay screen, or content with age restriction.

FIG. 11 is a diagram illustrating a modification of changing of a projection position. In the example illustrated in FIG. 10, a case where the projection position of the content G11 on the wall surface 80-2 changes has been described. In the example illustrated in FIG. 11, a projection position of content G13 is changed to a top surface of the table 80-4 (content G14). Thus, the projection position of the content G13 may be changed to any object in the space 70.

In accordance with control by a presentation control unit 113, the projection position reaches a projection position after change from the projection position before the change via a change route. At this time, in a case where a person (for example, a child) is within a predetermined range corresponding to the projection position before the change (hereinafter, also referred to as “irradiation prohibited area”), light projected by the presentation unit 40 during change of the projection position may hit a person and be harmful to health of the person. Therefore, the presentation control unit 113 preferably controls a change route of the projection position on the basis of whether or not there is a person in the irradiation prohibited area.

More specifically, in a case where there is a person in the irradiation prohibited area, the presentation control unit 113 may determine the change route so as to avoid an area corresponding to the person. The area corresponding to a person is not limited. For example, the area corresponding to a person may be a region based on a position of the person (for example, a region where there is no person). Meanwhile, in a case where there is no person in the irradiation prohibited area, the presentation control unit 113 may determine a shortest route joining positions before and after changing the projection position to be a change route.

Here, the irradiation prohibited area is not particularly limited. For example, the irradiation prohibited area may be a region based on a projection position before change, or a region based on the projection position before the change and a projection position after the change. A shape of the irradiation prohibited area is not particularly limited.

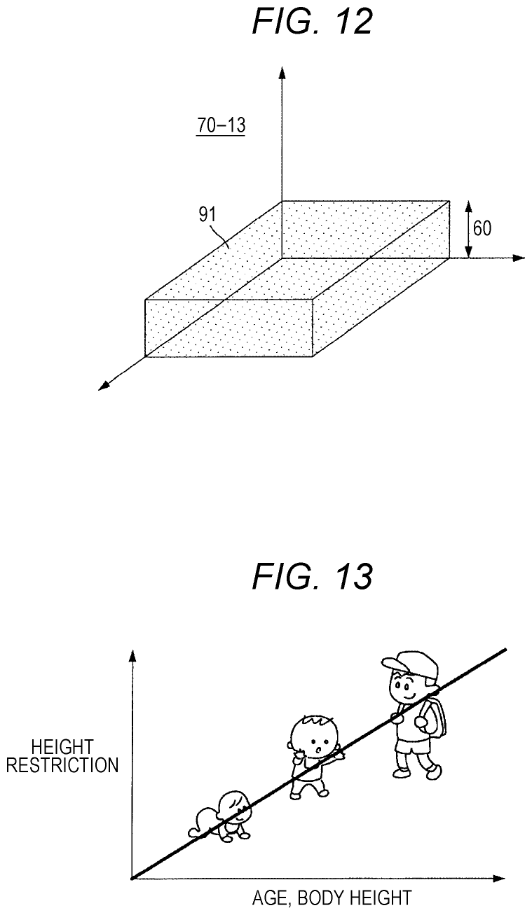

FIG. 12 is a diagram illustrating an example of an irradiation prohibited area. As illustrated in FIG. 12, an irradiation prohibited area 91 may have a rectangular parallelepiped shape. However, a shape of the irradiation prohibited area 91 is not limited. Furthermore, although a size of the irradiation prohibited area 91 may be unchanged, it is preferable that the size of the irradiation prohibited area 91 changes over time. Here, as an example of the size of the irradiation prohibited area 91, a case where height 60 of the irradiation prohibited area. 91 changes will be described.

FIG. 13 is a diagram illustrating an example of setting of height of an irradiation prohibited area.

With reference to FIG. 13, a graph illustrating a correspondence between age (or body height) of a child and a height restriction on an irradiation position (that is, the height 60 of the irradiation prohibited area 91) is illustrated. The presentation control unit 113 may increase the height 60 of the irradiation prohibited area 91 as the child grows older (or taller), on the basis of such a correspondence. With this arrangement, a possibility of an eye of a child being irradiated with light can be reduced.

After determining a change route, the presentation control unit 113 changes a projection position of the content in accordance with the change route. Note that, when changing the projection position, the presentation control unit 113 may add a motion accompanied by animation to the content, or may adjust an intensity of a light source with which the content is irradiated.

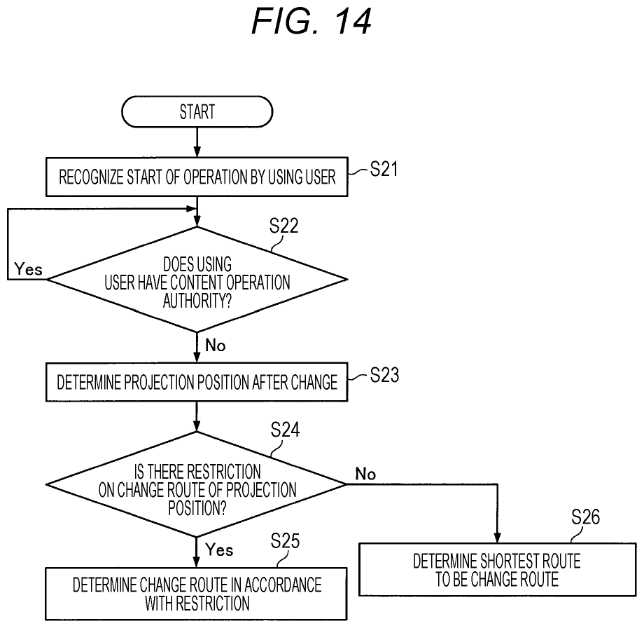

FIG. 14 is a flowchart illustrating a flow of projection position control in a case where there is one user. As illustrated in FIG. 14, when start of operation by a using user is recognized (S21), the presentation control unit 113 judges whether or not the using user has content operation authority (S22). In a case where the using user has the content operation authority (“Yes” in S22), the presentation control unit 113 maintains the projection position of the content and returns to S22.

Meanwhile, in a case where the using user does not have the content operation authority (“No” in S22), the presentation control unit 113 determines a projection position after change (S23) and judges whether or not there is a restriction on a change route of the projection position (S24). In a case where there is a restriction on the change route of the projection position (“Yes” in S24), the presentation control unit 113 determines the change route in accordance with the restriction. (S25). Meanwhile, a case where there is no restriction on the change route of the projection position (“No” in S24), the presentation control unit 113 determines the shortest route to be the change route (S26). After determining a change route, the presentation control unit 113 changes the projection position in accordance with the change route.

An example of projection position control in a case where there is one user in space as been described above.

(1.3.3. Projection Position Control: Operation Authority for Plurality of Users)

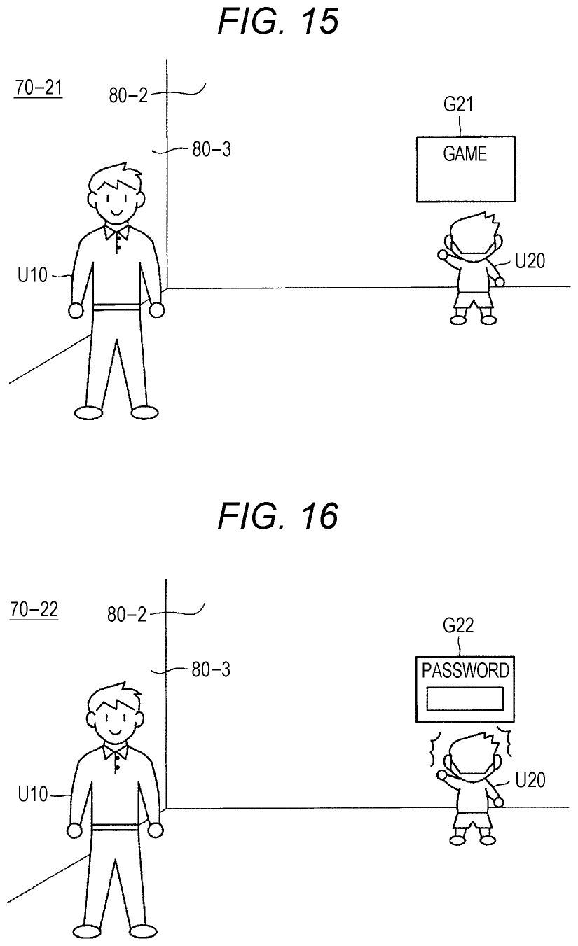

Projection position control in a case where there is one user in space has been described above. However, there may be a plurality of users in space. In the following, an example of projection position control in a case where there is a plurality of users in space will be described. First, with reference to FIGS. 15 to 17, an example of projection position control in a case where there is a plurality of users in space (in a case where operation authority is considered) will be described.

FIGS. 15 to 17 are diagrams for describing an example of projection position control in a case where there is a plurality of users in space (in a case where operation authority is considered). With reference to FIG. 15, there are the user U10 “father” and the user U20 “son” in space 70-21. When start of operation by the user U20 “son” is recognized, the presentation control unit 113 recognizes the user U20 “son” as a using user.

In the example illustrated in FIG. 15, a plurality of users (here, user U10 “father” and user U20 “son”) is in the same space 70-21 as the projection position of content G21. In this case, the presentation control unit. 113 is only required to control a projection position on the basis of operation authority information of a user (using user=user U20 “son”) closest to the projection position of content G22.

Here, it is assumed that the user U20 “son” has operation authority over content of which the content type is “game application”. Thus, in a case where content use authority information of the user U20 “son” indicates that the user U20 “son” has operation authority, the presentation control unit 113 maintains the projection position of the content G21. With this arrangement, the user U20 “son” who has authority can continue to operate the content G21.

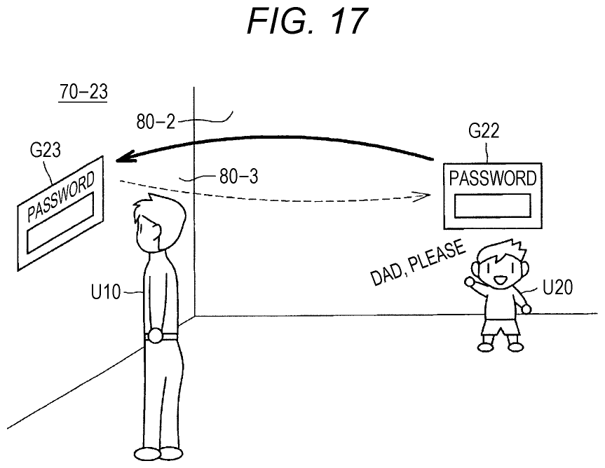

Next, with reference to FIG. 16, as similar to FIG. 15, there are the user U10 “father” and the user U20 “son” in space 70-22. However, the content type has been switched from the game application to a password input screen (content G22).

Here, it is assumed that the user U20 “son” does not have operation authority over content of which the content type is a password input screen. Meanwhile, it is assumed that the user U10 “father” has operation authority over content of which the content type is a password input screen. In this case, the presentation control unit 113 preferably changes the projection position on the basis of the position of the user U10 “father”.

More specifically, the presentation control unit 113 controls the presentation unit 40 so that content G23 is projected, by the presentation unit 40, at a position in space 70-23 (in the example illustrated in FIG. 17, the wall surface 80-3 that is a surface close to a position of the user U10 “father”) corresponding to a position of the user U10 “father”. With this arrangement, the user U10 “father” who has authority can start operating the content G23. Note that the presentation control unit 113 may return the projection position of the content to a position in the space 70-23 corresponding to the position of the user U20 “son” in a case where password input is completed by the user U10 “father”.

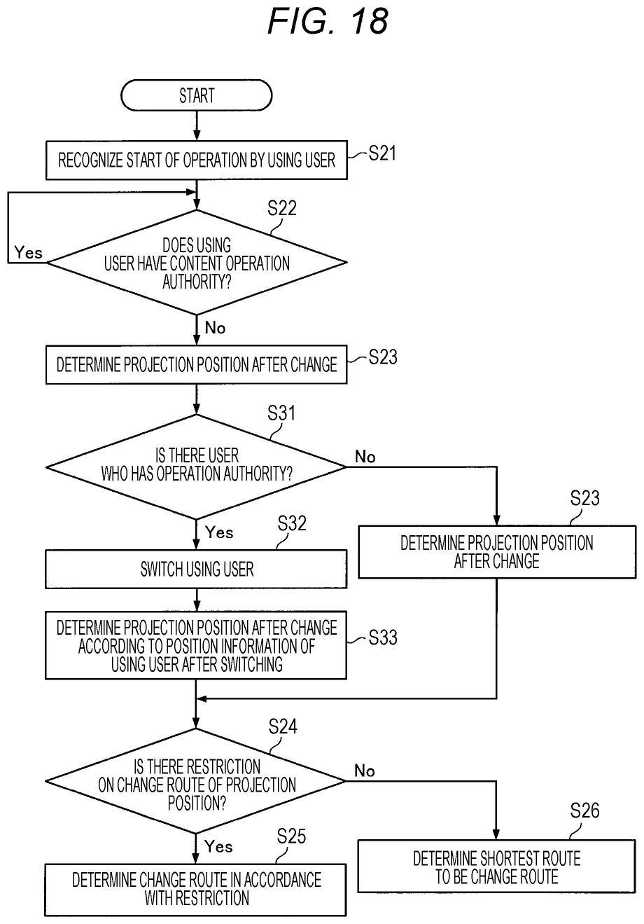

FIG. 18 is a flowchart illustrating a flow of projection position control in a case where there is a plurality of users in space (in a case where operation authority is considered). S21 to S23 illustrated in FIG. 18 are executed in a similar manner to S21 to S23 illustrated in FIG. 14. In a case where the using user does not have the content operation authority (“No” in S22), the presentation control unit 113 determines a projection position after change (S23) and judges whether or not there is a user who has operation authority in the space (S31). In a case where there is no user who has operation authority in the space (“No” in S31), the presentation control unit 113 executes S23 to S26. S23 to S26 illustrated in FIG. 18 are executed as similar to S23 to S26 illustrated in FIG. 14.

In a case where there is a user who has operation authority in the space (“Yes” in S31), the presentation control unit 113 switches the using user to a user who has the operation authority (S32), and determines a projection position after change according to the position information of the using user after the switching (S33). After determining a projection position after change, the presentation control unit 113 executes S24 to S26. S24 to S26 illustrated in FIG. 18 are executed as similar to S24 to S26 illustrated in FIG. 14.

An example of projection position control in a case where there is a plurality of users in space (in a case where operation authority is considered) has been described above.

(1.3.4. Projection Position Control: Browsing Authority for Plurality of Users)

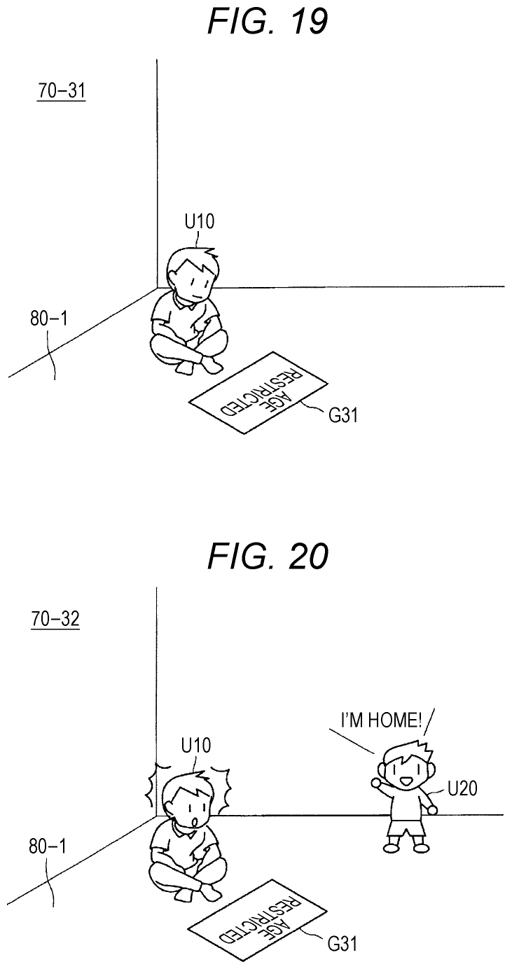

An example of projection position control in a case where there is a plurality of users in space (in a case where operation authority is considered) has been described above. In the following, an example of projection position control in a case where there is a plurality of users in space (in a case where browsing authority is considered) will be described. First, with reference to FIGS. 19 to 21, an example of projection position control in a case where there is a plurality of users in space (in a case were browsing authority is considered) will be described.

FIGS. 19 to 21 are diagrams for describing an example of projection position control in a case where there is a plurality of users in space (in a case where browsing authority is considered). With reference to FIG. 19, there is only the user U10 “father” in space 70-31. When start of operation by the user U10 “father” is recognized, the presentation control unit 113 recognizes the user U10 “father” as a using user and controls projection of content G31 on the basis of position information of the user U10 “father”.

More specifically, the presentation control unit 113 controls the presentation unit 40 so that the content G31 is projected, by the presentation unit 40, at a position in space 70-31. (in the example illustrated in FIG. 19, a surface close to a position of the user U10 “father” or the floor surface 80-1 that is a surface where a line of sight of the user U10 “father” meets) corresponding to position information of the user U10 “father”. At this time, the presentation control unit 113 controls the projection position of the content G31 on the basis of content use authority information of the user U10 “father” related to the content G31.

Here, it is assumed that the user U10 “father” has browsing authority over content of which the content type is “with age restriction”. Thus, in a case where the content use authority information of the user U10 “father” indicates that the user U10 “father” has browsing authority, the presentation control unit 113 maintains the projection position of the content G31. Thereafter, as illustrated in FIG. 20, it is assumed that the user U20 “son” as an example of another user enters space 70-32.

In the example illustrated in FIG. 19, a plurality of users (here, user U10 “father” and user U20 “son”) is in the same space 70-32 as the projection position of the content G31. In this case, the presentation control unit 113 is only required to control a projection position on the basis of browsing authority information of each of the plurality of users. More specifically, if there is at least one user who does not have browsing authority in the space, the presentation control unit 113 changes the projection position of the content on the basis of position information of the user who does not have the browsing authority. Meanwhile, in a case where all of the plurality of users have the browsing authority, the presentation control unit 113 may maintain the projection position of the content.

Here, it is assumed that the user U20 “son” does not have operation authority over content of which the content type is “with age restriction”. Thus, in a case where content use authority information of the user U20 “son” indicates that the user U20 “son” does not have browsing authority, and content use authority information of the user. U10 “father” indicates that the user U10 “father” has browsing authority, the presentation control unit 113 preferably changes the projection position on the basis of the position information of the user U10 “father”.

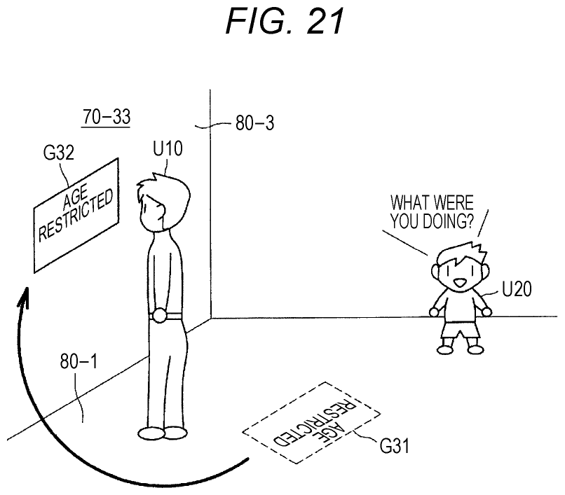

More specifically, the presentation control unit 113 controls the presentation unit 40 so that content G32 is projected, by the presentation unit 40, at a position in the space 70-23 (in the example illustrated in FIG. 21, a surface close to a position of the user U10 “father” or the wall surface 80-3 that is a surface where a line of sight of the user U10 “father” meet corresponding to position information of the user U10 “father”. With this arrangement, the user U10 “father” who has the browsing authority can continue to browse the content G32 so as not to be noticed by the user U20 “son”.

Note that, in a case where there is a user who does not have browsing authority in space, the presentation control unit 113 may erase content instead of changing the projection position of the content, or a part of output (for example, voice output, or the like) may be stopped. Alternatively, if whether to change a projection position of content or erase the content is set, the presentation control unit 113 may control the content on the basis of the setting. The setting may be previously performed, or may be performed each time a user who does not have browsing authority is detected.

The presentation control unit 113 may reduce a size of content when changing a projection position of the content. With this arrangement, the content is less noticeable by the user U20 “son”. Furthermore, as similar to the above-description, in a case where there is a person (for example, a child) in the irradiation prohibited area, the presentation control unit 113 may determine a change route so as to avoid an area corresponding to the person when changing a projection position of the content.

Furthermore, although there is only one user who has browsing authority in space in the above description, there may be a plurality of users who has the browsing authority in the space. In this case, browsing priority may be linked to the plurality of users. By doing so, the presentation control unit 113 can also circulate the content among the plurality of users by changing the projection position of the content in descending order of the browsing priority.

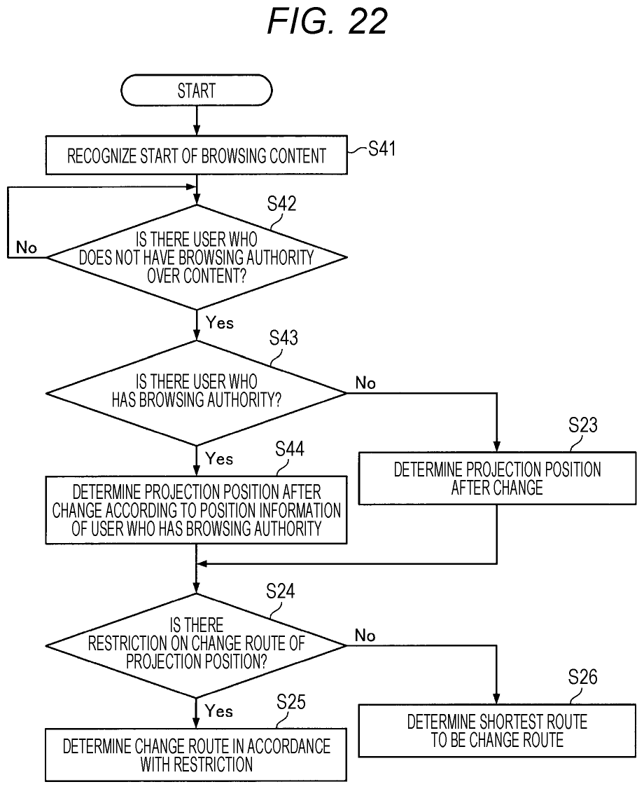

FIG. 22 is a flowchart illustrating a flow of projection position control in a case where there is a plurality of users in space (in a case where browsing authority is considered). As illustrated in FIG. 22, when start of browsing content is recognized (S41), the presentation control unit 113 judges whether or not there is a user who does not have browsing authority over the content in the space (S42). In a case where there is no user who does not have browsing authority over the content in the space (“No” in S42), the presentation control unit 113 executes S23 to S26. S23 to S26 illustrated in FIG. 22 are executed as similar to S23 to S26 illustrated in FIG. 14.

Meanwhile, in a case where there is a user who does not have browsing authority over the content in the space (“Yes” in S42), the presentation control unit 113 judges whether or not there is a user who has browsing authority over the content in the space (S43). In a case where there is no user who has browsing authority over the content in the space (“No” in S43), the presentation control unit 113 executes S23. Meanwhile, in a case where there is, in the space, a user for whom browsing the content is restricted (“Yes” in S43), the presentation control unit 113 determines a projection position after change according to the position information of a user who has browsing authority (S44), and executes S24 to S26. S24 to S26 illustrated in FIG. 22 are executed as similar to S24 to S26 illustrated in FIG. 14.

An example of projection position control in a case where there is a plurality of users in space (in a case where browsing authority is considered) has been described above.

[1.4. Hardware Configuration Example]

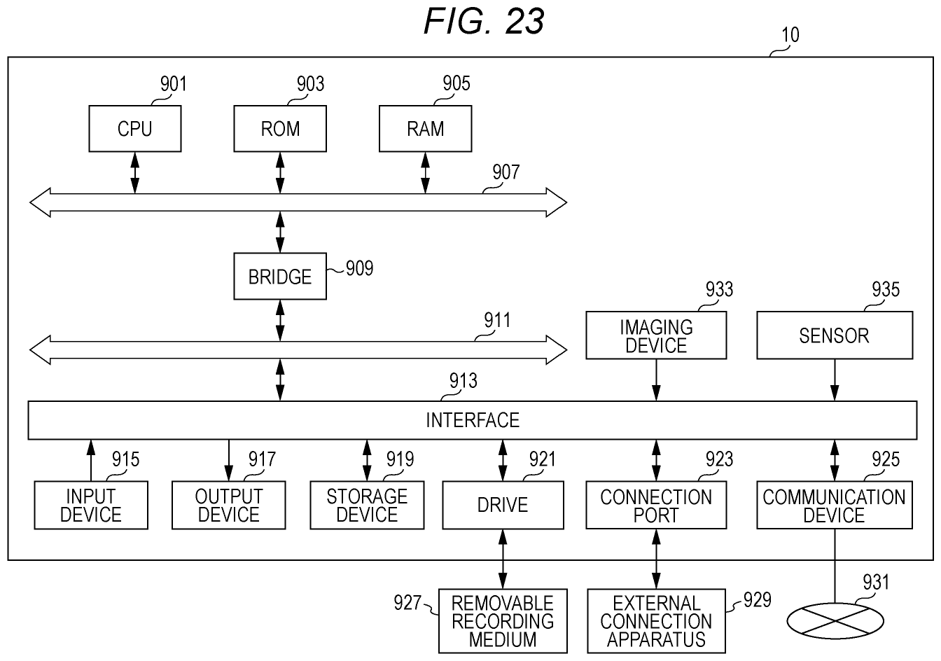

Next, a hardware configuration of the information processing device 10 according to the embodiment of the present disclosure will be described with reference to FIG. 23. FIG. 23 is a block diagram illustrating a hardware configuration example of the information processing device 10 according to the embodiment of the present disclosure.

As illustrated in FIG. 23, the information processing device 10 includes a central processing unit (CPU) 901, a read only memory (ROM) 903, and a random access memory (RAM) 905. Furthermore, the information processing device 10 may include a host bus 907, a bridge 909, an external bus 911, an interface 913, an input device 915, an output device 917, a storage device 919, a drive 921, a connection port 923, and a communication device 925. Moreover, the information processing device 10 may include an imaging device 933 and a sensor 935 as necessary. The information processing device 10 may have a processing circuit called digital signal processor (DSP) or application specific integrated circuit (ASIC) in place of or in addition to the CPU 901.

The CPU 901 functions as an arithmetic processing unit and a control device, and controls an entire or a part of operation in the information processing device 10 in accordance with a program of various kinds recorded in the ROM 903, the RAM 905, the storage device 919, or a removable recording medium 927. The ROM 903 stores a program, a calculation parameter, or the like, that is used by the CPU 901. The RAM 905 temporarily stores a program used in execution of the CPU 901, a parameter that changes as appropriate in the execution, or the like. The CPU 901, the ROM 903, and the RAM 905 are interconnected by the host bus 907 configured by an internal bus such as a CPU bus. Moreover, the host bus 907 is connected to the external bus 911 such as a peripheral component interconnect/interface (PCI) bus via the bridge 909.

The input device 915 is a device such as a mouse, a keyboard, a touch panel, a button, a switch, and a lever for example, which is operated by a user. The input device 915 may include a microphone that detects voice of a user. The input device 915 may be, for example, a remote control device using infrared light or another radio wave, or may be an external connection apparatus 929 such as a mobile phone corresponding to operation of the information processing device 10. The input device 915 includes an input control circuit that generates an input signal on the basis of information input by a user and outputs the input signal to the CPU 901. By operating this input device 915, the user inputs various kinds of data to the information processing device 10, or gives an instruction on processing operation. Furthermore, the imaging device 933 as described later may function as an input device by capturing an image of movement of a hand of a user, a finger of the user, or the like. At this time, a pointing position may be determined according to the movement of the hand or the orientation the finger.

The output device 917 is configured by a device capable of visually or auditorily notifying the user of acquired information. The output device 917 may be, for example, a liquid crystal display (LCD), a plasma display panel (PDP), an organic electro-luminescence (EL) display, a display device such as a projector, a hologram display device, a sound output device, such as a speaker and headphone, or a printer device, or the like. The output device 917 outputs a result obtained by processing by the information processing device 10 as a screen image of text, an image, or the like, or sound such as voice or audio. Furthermore, the output device 917 may include a light such as a light-emitting diode (LED).

The storage device 919 is a data storage device configured as an example of a storage unit of the information processing device 10. The storage device 919 includes, for example, a magnetic storage unit device such as a hard disk drive (HDD), a semiconductor storage device, an optical storage device, or a magneto-optical storage device. The storage device 919 stores a program executed by the CPU 901, various kinds of data, various kinds of data acquired from an outside, or the like.

The drive 921 is a reader/writer for the removable recording medium 927 such as a magnetic disk, an optical disk, a magneto-optical disk, or a semiconductor memory, and built in or externally attached to the information processing device 10. The drive 921 reads information recorded in the removable recording medium 927 that is mounted and outputs the information to the PAM 905. Furthermore, the drive 921 writes record in the removable recording medium 927 that is mounted.

The connection port 923 is a port for directly connecting an apparatus to the information processing device 10. The connection port 923 may be, for example, a universal serial bus (USB) port, an IEEE1394 port, a small computer system interface (SCSI) port, or the like. Furthermore, the connection port 923 may be an RS-232C port, an optical audio terminal, a high-definition multimedia interface (HDMI (registered trademark)) port, or the like. By connecting the external connection apparatus 929 to the connection port 923, various kinds of data may be exchanged between the information processing device 10 and the external connection apparatus 929.

The communication device 925 is, for example, a communication interface including a communication device, or the like, for connecting to a communication network 931. The communication device 925 may be, for example, a communication card for a wireless USB (WUSB), a wired or wireless local area network (LAN), Bluetooth (registered trademark), or the like. Furthermore, the communication. device 925 may be a router for optical communication, router for asymmetric digital subscriber line (ADSL), modem for communication of various kinds, or the like. The communication device 925 transmits and receives a signal, or the like, with, for example, the Internet or another communication apparatus by using a predetermined protocol such as TCP/IP. Furthermore, the communication network 931 connected to the communication device 925 is a network connected by wire or wirelessly, and is, for example, the Internet, a home LAN, infrared communication, radio wave communication, satellite communication, or the like.

The imaging device 933 is a device that images real space by using, for example, an image sensor such as a charge coupled device (CCD) or a complementary metal oxide semiconductor (CMOS), and a member of various kinds such as a lens for controlling image formation of an object image to the image sensor, and generates a captured image. The imaging device 933 may capture a still image, or may capture a moving image.

The sensor 935 is, for example, a sensor of various kinds, such as a distance measuring sensor, an acceleration sensor, a gyro sensor, a geomagnetic sensor, a vibration sensor, a light sensor, or a sound sensor. The sensor 935 acquires information regarding surrounding environment of the information processing device 10, such as information regarding a state of the information processing device 10 itself including, for example, posture of a housing of the information processing device 10, brightness or noise surrounding the information processing device 10, or the like. Furthermore, the sensor 935 may include a global positioning system (GPS) sensor that receives a GPS signal and measures a latitude, longitude, and altitude of a device.

<2. Conclusion>

As described above, according to the embodiment of the present disclosure, there is provided an information processing device including a presentation control unit that controls presentation or content on the basis of a position of a first user, in which the presentation. control unit controls a presentation position of the content in space on the basis of use authority information of the first user regarding the content. With this configuration, it is possible to control presentation of content so as to improve user convenience.

Furthermore, in the embodiment of the present disclosure, a system automatically understands a using user and automatically switches the using user, and therefore, it is possible to save time and effort to reset parental control manually. Furthermore, in the embodiment of the present disclosure, a user can be anywhere in space to operate content, because the content may be presented at any area in the space. Furthermore, in the embodiment of the present disclosure, a single piece of content may be presented by a drive-type projector, and therefore, discomfort and danger to the user by irradiation from the drive-type projector may be reduced as compared with a case were a plurality of pieces of content is presented.

A preferred embodiment of the present disclosure has been described in detail with reference to the appended drawings, but the technical scope of the present disclosure is not limited to such examples. It is obvious that a person with an ordinary skill in a technological field of the present disclosure could conceive of various alterations or corrections within the scope of the technical ideas described in the appended claims, and it should be understood that such alterations or corrections may naturally belong to the technical scope of the present disclosure.

Furthermore, the effects described in the present specification are merely illustrative or exemplary and are not limitative. That is, the technique according to the present disclosure may exhibit other effects obvious to those skilled in the art from the description of the present specification in addition to or in place of the above-described effects.

Note that the following configurations also belong to the technical scope of the present disclosure.

(1)

An information processing device including a. presentation control unit that controls presentation of content on the basis of position information of a first user, in which the presentation control unit controls a presentation position of the content in space on the basis of use authority information of the first user regarding the content.

(2)

The information processing device according to (1),

in which the presentation control unit changes the presentation position in a case where the use authority information of the first user regarding the content indicates that the first user does not have the use authority over the content.

(3)

The information processing device according to (1) or (2),

in which the presentation control unit moves the presentation position away from the first user in a case where the use authority information of the first user regarding the content indicates that the first user does not have the use authority over the content.

(4)

The information processing device according to (3),

in which the presentation control unit changes the presentation position on the basis of position information of a second user in a case where use authority information of the second user regarding the content indicates that the second user has the use authority over the content.

(5)

The information processing device according to any one of (1) to (4),

in which the presentation control unit maintains the presentation position in a case where the use authority information of the first user regarding the content indicates that the first user has the use authority over the content.

(6)

The information processing device according to any one of (1) to (5),

in which the presentation control unit controls a change route of the presentation position on the basis of whether or not there is a person within a predetermined range corresponding to the presentation position.

(7)

The information processing device according to (6),

in which the presentation control unit determines the change route to avoid an area corresponding to a person in a case where there is the person within the predetermined range corresponding to the presentation position.

(8)

The information processing device according to (6) or (7),

in which the presentation control unit determines a shortest route joining positions before and after changing the presentation position to be the change route in a case where there is no person within the predetermined range corresponding to the presentation position.

(9)

The information processing device according to any one of (1) to (8),

in which the information processing device includes an acquisition unit that acquires the use authority information of the first user regarding the content that is linked to the content or a type of the content and to an attribute of the first user.

(10)

The information processing device according to any one of (1) to (8),

in which the presentation control unit determines use authority information of the first user regarding the content on the basis of a relation between a level linked to the content or the type of the content and a level linked to the attribute of the first user.

(11)

The information processing device according to any one of (1) to (8),

in which the presentation control unit determines use authority information of the first user regarding the content on the basis of presentation area restriction information linked to the attribute of the first user.

(12)

The information processing device according to any one of (1) to (8),

in which the presentation control unit determines use authority information of the first user regarding the content on the basis of time restriction information linked to the attribute of the first user.

(13)

The information processing device according to any one of (1) to (12),

in which the use authority information of the first user regarding the content includes content browsing authority information of the first user.

(14)

The information processing device according to (13),

in which the presentation control unit controls the presentation position on the basis of content browsing authority information of each of a plurality of users in a case where there is the plurality of users including the first user in the same space as the presentation position.

(15)

The information processing device according to any one of (1) to (14),

in which the use authority information of the first user regarding the content includes content operation authority information of the first user.

(16)

The information processing device according to (15),

in which the presentation control unit determines a user who is closest to the presentation position among a plurality of users to be the first user, and controls the presentation position on the basis of the content operation authority information of the first user in a case where there is the plurality of users in the same space as the presentation position.

(17)

The information processing device according to any one of (1) to (16),

in which the first user and the presentation. position are in the same space.

(18)

The information processing device according to any one of (1) to (17),

in which a presentation device that presents the content includes a projector.

(19)

An information processing method including, by a processor:

controlling presentation of content on the basis of position information of a first user, and

controlling a presentation position of the content in space on the basis of use authority information of the first user regarding the content.

(20)

A program for causing a computer to function as an. information processing device including a presentation control unit that controls presentation of content on the basis of position information of a first user,

in which the presentation control unit controls a presentation position of the content in space on the basis of use authority information of the first user regarding the content.

### REFERENCE SIGNS LIST

1 Information processing system

10 Information processing device

110 Control unit

120 Storage unit

111 Acquisition unit

113 Presentation control unit

20 Sensor unit

40 Presentation unit

70 Space

91 Irradiation prohibited area

1. An information processing device comprising a presentation control unit that controls presentation of content on a basis of position information of a first user,
wherein the presentation control unit controls a presentation position of the content in space on a basis of use authority information of the first user regarding the content.

2. The information processing device according to claim 1,
wherein the presentation control unit changes the presentation position in a case where the use authority information of the first user regarding the content indicates that the first user does not have the use authority over the content.

3. The information processing device according to claim 1,
wherein the presentation control unit moves the presentation position away from the first user in a case where the use authority information of the first user regarding the content indicates that the first user does not have the use authority over the content.

4. The information processing device according to claim 3,
wherein the presentation control unit changes the presentation position on a basis of position information of a second user in a case where use authority information of the second user regarding the content indicates that the second user has the use authority over the content.

5. The information processing device according to claim 1,
wherein the presentation control unit maintains the presentation position in a case where the use authority information of the first user regarding the content indicates that the first user has the use authority over the content.

6. The information processing device according to claim 1,
wherein the presentation control unit controls a change route of the presentation position on a basis of whether or not there is a person within a predetermined range corresponding to the presentation position.

7. The information processing device according to claim 6,
wherein the presentation control unit determines the change route to avoid an area corresponding to a person in a case where there is the person within the predetermined range corresponding to the presentation position.

8. The information processing device according to claim 6,
wherein the presentation control unit determines a shortest route joining positions before and after changing the presentation position to be the change route in a case where there is no person within the predetermined range corresponding to the presentation position.

9. The information processing device according to claim 1,
wherein the information processing device includes an acquisition unit that acquires the use authority information of the first user regarding the content that is linked to the content or a type of the content and to an attribute of the first user.

10. The information processing device according to claim 1,
wherein the presentation control unit determines use authority information of the first user regarding the content on a basis of a relation between a level linked to the content or the type of the content and a level linked to the attribute of the first user.

11. The information processing device according to claim 1,
wherein the presentation control unit determines use authority information of the first user regarding the content on a basis of presentation area restriction information linked to the attribute of the first user.

12. The information processing device according to claim 1,
wherein the presentation control unit determines use authority information of the first user regarding the content on a basis of time restriction information linked. to the attribute of the first user.

13. The information processing device according to claim 1,
wherein the use authority information of the first user regarding the content includes content browsing authority information of the first user.

14. The information processing device according to claim 13,
wherein the presentation control unit controls the presentation position on a basis of content browsing authority information of each of a plurality of users in a case where there is the plurality of users including the first user in a same space as the presentation position.

15. The information processing device according to claim 1,
wherein the use authority information of the first user regarding the content includes content operation authority information of the first user.

16. The information processing device according to claim 15,
wherein the presentation control unit determines a user who ifs closest to the presentation position among a plurality of users to be the first user, and controls the presentation position on a basis of the content operation authority information of the first user in a case where there is the plurality of users in a same space as the presentation position.

17. The information processing device according to claim 1,
wherein the first user and the presentation position are in a same space.

18. The information processing device according to claim 1,
wherein a presentation device that presents the content includes a projector.

19. An information processing method comprising, by a processor:
controlling presentation of content on a basis of position information of a first user, and
controlling a presentation position of the content in space on a basis of use authority information of the first user regarding the content.

20. A program for causing a computer to function as an information processing device comprising a presentation control unit that controls presentation of content on a basis of position information of a first user,
wherein the presentation control unit controls a presentation position of the content in space on a basis of use authority information of the first user regarding the content.
